(19) United States
(12) Patent Application Publication
(10) Pub. No.: US 2025/0003433 A1
(43) Pub. Date: Jan. 2, 2025

(54) METHOD AND APPARATUS FOR IMPROVING FLUID BEHAVIOR AND PERFORMANCE

(71) Applicant: Edward Joseph Mathieu, Salt Lake City, UT (US)

(72) Inventor: Edward Joseph Mathieu, Salt Lake City, UT (US)

(21) Appl. No.: 18/433,425

(22) Filed: Feb. 6, 2024

Related U.S. Application Data
(60) Provisional application No. 63/576,367, filed on Feb. 6, 2023.

(51) Int. Cl. F15D 1/02; C02F 1/48; C02F 103/06

(52) U.S. Cl. CPC F15D 1/02; C02F 1/481; C02F 2103/06

(57) ABSTRACT

A method and apparatus for improving fluid behavior and performance by a magnetic field interacting with a flowing fluid. The field strength is adjusted relative to the speed of the fluid flow to achieve improved results of the fluid flow, including but not limited to, optimal efficiency of results. In this regard, combined speed and optimal magnetic field strength was determined for various pipe sizes to achieve greatly improved results. The signature strength may be adjusted by using an inventive field magnet mounting disc assembly 16 for employing one or more permanent magnet rods inside a flowing fluid.

### CROSS-REFERENCE TO RELATED APPLICATION

This utility patent application is related to and is a continuation-in-part of U.S. Provisional Patent Application, No. 63/576,367, filed on Feb. 6, 2023, by the same Inventor as this U.S. Utility Patent Application.

### BACKGROUND OF THE INVENTION

Since the 1960's many devices and treatments have come to the U.S. market to address the negative impacts of poor water quality. For example, conventional water softeners commonly used today. Newer approaches attempt to target the root problem of poor water quality, such as heavy bicarbonates and simple hard water. Poor water quality can impact the efficiency of all piping and pumping systems, making them wasteful. Moreover, poor water quality can not only be a major deterrent in crop and plant production, but also can cause deterioration of soil health over time.

Currently there exists potable water shortages in many parts of the world. Technologies and products have been employed in an attempt to address the crisis of global water scarcity, contamination and pollution of major water bodies. There still remains a desperate need for solutions to these problems. New concepts in all facets of water equality are highly sought after by federal and regional water agencies in need of new methods for reducing costs for water use and eliminating or reducing contamination points associated with growing food.

To date there have been many attempts to improve water quality by using complex and expense to manufacture, sell, and use technologies such as:
1. Electromagnetic field inducing,
2. Vortex inducing,
3. O-Zone injection,
4. Magnetic field inducing, and
5. Nano-bubble injection.

For decades, various forms of technology such as the above stated technologies have attempted to modify water quality for better performance. None have worked entirely satisfactorily and consistently. None provided a solid solution in mainstream markets, mainly because of associated initial capital costs. In addition, many technologies are not only expensive to own but also to operate, requiring on-going operational costs or regular service agreements. Some are designed around large, power-consuming equipment, with bulky devices or appliances that in many cases are not very customer or maintenance friendly.

Current major manufacturers of water improvement techniques are, as follows:
1. Aqua-Rex,
2. Flow-Tech,
3. Magnation,
4. GMX International, and
5. Trentatron.

Water quality improvement is currently needed in many different applications including but not limited to agricultural irrigation water for growing crops and plants. Poor water quality adversely affects the quality of the soil used to grow crops and plants. Water run off can occur. Also soil penetration by water to plant and thus, water used for irrigation can result in crop roots can be ineffective. Therefore, irrigation water currently being employed can be far less than desirable. As a result, the crops and plants when harvested, can have an undesirable yield and/or a less than robust and healthy product. Also, it would be highly desirable to use less water to achieve desired crop production. By using less water, a natural resource is preserved, and less electrical power is required for pumping the water.

### BRIEF SUMMARY OF THE INVENTION

As a result of various experiments, supervised by me at my request, it was determined by trial and error that the industry known and standardized as the ‘optimum’ amount of water applied to plant material is flawed and not in fact accurate for certain situations and circumstances. My preferred approach applies simple, natural, permanent magnetic field methodology, that positively impacts all water types at a cellular level. I do this by noting a crucial velocity (time) while staying within industry standard fluid design hydraulics and industry practice. And with my understanding that the magnet field strength, from permanent magnets (gauss) is a direct relation to its ability to disrupt flowing molecules and re-order them to bring about a different, unique and special behavior. The disrupting and re-ordering of flowing molecules by using electric and/or magnetic fields is discussed in a book entitled “The Fourth Phase of Water”, by Dr. Gerald Pollack, or later investigations by me.

For my experiments, I attached rare-earth permeant magnets on water pipes to create magnetic fields to re-order the water molecules flowing through the pipes. The strength of the magnetic field for each pipe was adjusted on a trial-and-error basis by adding and/or removing magnetic units until the magnets provided optimum results. I increased or decreased the magnetic field by adding stronger magnets, or removing some of the magnets, and orienting them in different arrangements to optimize the results achieved. It was crucial to generate, hold and maintain a very strong magnetic field alignment in the pipe. Center flux with neodymium magnets in the water supply pipes, provided a steady reaction with atoms, and also created a strong attractive force.

I used permanent magnets manufactured under the trade names Maximum H2O, GMX, and also Trentatronic. The Maximum H20 magnets were purchased from Maximum H20 located in Mississauga, ON, Canada. The GMX magnets were purchased from GMX International, 13771 Rosswell Avenue, Chino, California. The Trentatron magnets were obtained from Trentatronics, 2805 Enchanted Circle, Garland, Texas.

I found that all the magnets supplied worked well. Also, other approaches such as electromagnetic source magnets work as well in limited conditions. The permanent magnets used in my experiments were neodymium which is considered the strongest permanent magnet currently available.

No energy source such as electric power, of any kind is required to start or maintain its operation, and no equipment is needed for injection of any substance, or air. Minimal service, if any is required with no ongoing service is usually necessary.

The cost to implement and operate my method including devices to produce the desired results to the changes of physical water properties to improve water quality, is very inexpensive. There is substantially no ongoing operational costs, nor training required.

What was surprising, amongst other things, was the actual results of using my method. For example, in each trial experiment where real, visual and empirical data was collected, the results showed a positive net impact on plant growth, health and production—with a major reduction in water applied, these results greatly surpassed expectation, as compared to conventional standards.

In one experiment for turf grass at a city park in Salt Lake City, a Rocky Mountain area—that was considered by the parks department as the lowest quality (turf and playing surface) park in the city. Based on the current known industry standard water requirements, through commercial irrigation, the need for turf is approximately 30 inches to 33 inches, per growing season in the rocky mountain area based on evapotranspiration (ETc) including location and soil type.

After a season long evaluation (May to October) the city park using my magnetizing method being employed. The overall season use or irrigation applied to turf areas was found by me to be in fact an optimum amount of only approximately 24 inches to 26 inches. This amount of water was far below industry standard, and very far below what is generally actually applied by everyday operators and water customers, which is about 60 inches or more in the same city region. I found, as a result of my experiment on turf grass a monetary savings in dollar units, between the difference of standard ET 30 inches to 33 inches and my actual applied numbers of 24 inches to 26 inches from using my method was approximately $7,000.00 in one 6-month season. This cost savings should continue year after year on an on-going basis. The return on investment was approximately four months, and thereafter would be cost free. It is important to point out that once the magnetic unit was employed according to my methods in May, there was no engagement with, nor reason to encounter or interact with the magnet unit during the season.

My velocity standard:
I found that the speed in which the water moves through the magnetic field is very important to my method. The ability of the magnetic field to have significant impression on the flowing water molecular structure to produce desirable unexpected results. I have found that although magnetic fields in general can have an affect on water, pin-pointing optimal magnet strength directly contributes to optimal results. Low water velocity and higher velocities delivery different outcomes. I have found that the following table shows optimum ranges for water velocity for flowing through a supply pipe.

| | |
|---|---|
| Good: 3 to18 feet per second | Good: operational flow range |
| Better: 4 to12 feet per second | Better: working flow range |
| Best: 6 feet per second | Best: optimal flow target |

The flow rates are a significant indication of the operational efficiency of the irrigation process resulting from the use of my process. As shown in the above table, optimal velocity rates of the water are identified.

My gauss requirements were also important to help cause improved results. I found that the strength of the magnetic field generated by the ability of the North and South poles of the permanent magnets to have significant push and pull. Furthermore, I found that the pull strength is a major factor in determining the magnetics ability to create an effective field on water's mineral chemistry. I additionally found that magnet orientation is also a key factor in creating highly effective magnetic fields.

It is important to have a paralleling north and south polarity, that crisscross sides in order to establish an effective magnetic field that will properly impact orientation of molecule clusters and physical structure to achieve desired gauss strength.

Magnetic strength measured in Gauss for pipe size are as follows:

| | | |
|---|---|---|
| 1 inch pipe | 5800-4400 Gauss | Good: operational range |
| | 5500-4600 Gauss | Better: working range |
| | 5200 Gauss | Best: optimal target |
| 2 inch pipe | 4700-2300 Gauss | Good: operational range |
| | 4150-2800 Gauss | Better: working range |
| | 3550 Gauss | Best: optimal target |

While I preferably employed rare earth permanent magnets to establish my magnetic fields, other techniques such as electro-magnetic systems may be employed to establish similar magnetic fields according to my method. These fields can be effective, but must be able to match field strength and presence, in order to impact the water molecules at the necessary level of reorder according to my method.

From my research and experimentation, I noted short comings in prior known irrigation application and design for agronomics and fluid hydraulics. My field analysis has exposed a few commonly known design principles and, or ‘rules-of-thumb’ that come into question and are not found to be entirely correct for optimum use. The following relates to reasons for the short comings:
1. Engineers ‘up-size’ pipe diameters in an attempt to hit design flows as stated in standard and commonly used flow charts.
2. All water types do not behave the same way.
3. Engineers treat all water types the same in design and irrigation scheduling. Well water is not the same as tap water, or lake water and they do not behave the same in all systems.
4. It is assumed that water applied to soil is not completely absorbed by soil. Weather based smart irrigation controllers do make such aquations.
5. Which water type is conventionally not used in the conventional equation of evaporation (ET) rates of plant types.

The following are actual experiments or trials which were conducted under my supervision. The reports on which are found in the attached Appendix.

### Mooriah Dairy—Melba, ID Experiment: Silage Irrigation and Soil Health

Back in the fall of 2016, I applied my method to a 16-year-old Dairy, which was using well water to irrigate silage, and on a feed line for milk cows. Sick cows were often isolated with hydration issues. After over a decade of utilizing this harsh water source, the soil chemistry has highly toxic (in soil health standards) and was unperforming in growing silage for the dairy. The soil structure, chemistry and overall health was in poor state, leading to fledging yields and poor silage for the animals. Site water run-off after irrigation was another significant area of concern with the dairy, and the local state government.

The Dairy owners were considering site relocation to correct the issues, but instead my technology method was employed with agricultural sprinkler pivots. Soil health, silage quality and yield production were found to be significantly improved. A separate water feedline unit was installed for the 1200 head of cows.

First year results with the technology covered 5 large growing fields, with 1 field (#6) left untreated for control, analysis from an independent consultant by the name of Thomas C. Hoffmann who is a consulting agronomist soil scientist, showed extreme improvement in the treated fields. Alfalfa yields for the season was extremely higher, and significantly improved. Water run-off had greatly declined to minimize small ponds in low areas.

Based on the attached the independent soil reports and evolution, soil chemistry moved into a more ‘balanced’ state—improving soil structure and health. Cows became hydrated, produced more bulk milk with higher percentages in protein and fat quantities.
Data of results provided by owner—year 1 over previous year: Alfalfa:
Treated fields: 613 bales/acre
Non-treated field: 308 bales/acre
Dairy:
% Fat: +6%
% Protein: +4.4%

### Evergreen Park Site-Salt Lake City, UT Experiment: Turf Grass

As mentioned briefly previously, the problematic trial site was selected in SLC to test and monitor data from the use of my magnetically influenced water technique. This site suffered with compaction of soil, inhibiting water penetration and turf growth, with high water use.

Pre magnet and post magnet distribution uniformity (DU) tests were conducted by Utah State University late April of 2020. Data from the University collected from state wide audits, have shown that water applied conventionally to irrigation in this region is >60+″.

As mentioned in the attached report, this experiment utilized a fully functioning weather-based irrigation controller. A 100% Automatic (no manual adjustments required) ET was scheduled for irrigation controller for 2020 season—May-September. This set-up, by conventional industry standard, apply approximately 33″ per growing season of water to the park turf areas. With usual hot summers, 33 inches would be far short of total water needed and applied. For the trial, and to evaluate the effectiveness of the magnetic field and my method, the scheduling values where set at a lower quantity of water; a deficit of −20% in May/June, a −25% deficit in July and a −30% deficit in August/September. It's important to note that 2020 was one of the hottest summers on record, with July and early August delivering the hottest days of the season.

Aside from the expectation a water audit would yield improvement to an irrigation system just by conducting one. It would be considered impossible without making any physical, mechanical or system pressure changes to the audited system. Median efficiency of typical commercial irrigation systems at 60%. However, it was officially recorded that by the installation of the magnet, in accordance with my novel method, that an improvement of 4-6% occurred, bringing site average to nearly 70% from the additional flow gained from the technology.

It was quickly noted, 30 days into the trial that the turf quality was improved over past seasons as it came out of winter dormancy and irrigation began. The spring and summer months were unseasonably hot. But by summers end the park had become a favorite and considered by many to be the healthiest, best looking with greatly improved turf quality.

Considered by most to be unlikely, the parks department removed the magnet and went back to ‘old’ irrigation scheduling for the following year. This action proved out to be the fastest way to return the park to an undesirable state of heath and appearance as seen in the photo and graph in the case study.

### San Isabel Power Cooperative—Electric Power Provider—Pueblo, CO Experiment: Energy Consumption Improvement

In my unique trial application of my method, at this site was tied to water flow and the typical amount of energy consumed to move a column of water through a pipe was observed. In this case-study the power company was struggling to achieve maximum velocity (delta t) through the piping system designed by mechanical engineers to a tooling tower. The hertz of 60 of a Variable Frequency Drive panel was not able to achieve full flow with pump station.

After years of struggling with the situation, there was concern that there was blockage in the feedline pipe, and it would take street excavation to locate and replace a section of an 8″ pipe.

In June of 2020 the mechanical operations department of the Pueblo, Colorado power company agreed to employ my novel method, with the main objective to attempt to descale pipes and cooling equipment on site, in hopes to reduce chemical use and save labor.

After the magnet installation of my method and an immediate restart of the pumping-station, it was noted by operations department that the VFD was running at 53 hertz, with a full flow at delta t. This 7-point reduction in power consumed by the VFD panel is expressed in higher energy saving with approximate three times (3×) savings in kilowatt power at the pump motors.

This allowed for maximum or optimum efficiency from the HVAC unit in addition to the improvement of lime scale reduction just after a few weeks in operation.

### Weber School District-Ogden, Utah: Water Use, Energy and Turf Quality

Weber school district is one of the largest districts in Utah with various water sources for irrigation. They are prime for new innovation and technology to aid in reducing water use at facilities around northern Utah. Weber Basin Water Agency has worked with them to implement technology and best management practices as a means to curb water use.

It was noted by the administration that most school sites in the district suffer from compaction, poor soil health, therefore turf quality. In an effort to reduce water use on the various grounds, my method was installed at two schools for trial. Both sites showed improvement in turf quality and water use reduction. Later the same summer, the school district installed a larger unit at a pump station at a Jr High school that was a problematic site since original construction in 2010. Data was collected at the pump station during installation that immediately showed an electrical energy reduction with the pump.

### Forest Dale Golf Course-Salt Lake City, Utah: Culinary Water Use and Turf Quality Trial

Forest Dale Golf Course is one of the original courses in Utah. Known as the first Salt Lake City Country Club location, Forest Dale is at the heart of Salt Lake and a cherished Utah Golf archive. Like most large areas of turf in the west, the course has struggled for the past decades with poor soil health. Permeation and infiltration are a major problem. Extreme summer stress resulted in poor turf health and rough ground conditions.

My method was installed mid-summer for a two-season water use and soil health trial. Within the first 30 days, the course showed significant improvement in turf overall condition and soil moisture holding capabilities.

### Mooriah Dairy—Experiment:

After 7 years of use, the Diary remains in operation due to the gradual improvements make to soil health and silage yields. After year 1 with magnets installed at pivots according to my method, the soil scientist noted major improvement with field water runoff was noticeable by lower ponding size in growing fields. Using my method caused a treated alfalfa field to outperform non-treated alfalfa fields by +50% (as noted above). Milk quality of dairy cows was enhanced with increases of milk fat % and milk protein %.

### Evergreen Park Site Experiment:

Industry standard is the use of evapotranspiration (ET) rates per plant type as a measure and indicator of water need. Since I managed this water schedule at −20/−25/−30% of ET, yet using my method, a remarkably heathy park of green turf at approximately two-thirds of the amount of water historically and professionally considered the park turf would need. We found that this changes the game by my determining the optimum need of water requirements per plant, and the validity of current ET values could be improved by using my new method.

At the park site it was noted by veteran city groundskeeper that the mature city trees (golden raintree) looked exceptionally better than past years. The groundskeeper noted less early season heat-wilt and leaf damage.

### Electric Power Cooperative—SIEA Experiment—Greater Flow Increase:

As noted in the attached report, in June of 2020 the system operated operator noted a consistent hertz reading of 60 on the variable frequency drive (VFD) achieved under Delta T flows, but after the installation of my process by employing magnetically influenced water, the new readings where lower at 53 hertz with full delta t. This 7-point reduction in hertz (at full flow) at the VFD using my method, in fact delivers a higher cost savings at the pump motors. This is a significantly high amount of energy savings from my method that works with water behavior at the cellular structure level. No excavation was required, and with the power savings alone—return on investment was 1 year.

Dr. Howard Neibling Extension Research Professor-University of Idaho: Magnetically Influenced Water with Water and Soil

In the spring of 2021, Professor Neibling conducted a series of site studies on potato and sugar beets. As a result of his investigation—using my method, demonstrated various improvements in irrigation performance, water to soil behavior, plant growth and health with increasing yields. See Appendix.

Remarkable water permeation and infiltration was noted, along with better flow and sprinkler head uniformity through the agricultural sprinkler pivots. Seedling emergence was higher along with sugar beet yields overall.

See attached report in the Appendix from Professor Neibling for test results.

### Weber School District Experiment-Tremendous Water Reduction

Water reductions without major changes to the existing irrigation system, generally show minimal savings, if any. At one of the sites that was closely monitored for water use, it was shown that a major reduction in landscape water use can be achieved without modifying existing equipment. An increase of system flow resulting in better distribution uniformity (DU) was noted. And within the first thirty days, the turf had responded to the treated water showing signs of new growth, better color with better infiltration. With the addition of my method, a 50% reduction in year over year water use was reported by the school district from the magnetically treated water.

The following is information concerning the magnetic strength of the magnetic unit for my method as well as the velocity. The 50% reduction in water use utilizing my method at the magnetic strength and velocity as achieved. This was accomplished without any change in the existing equipment:

Magnetic Strength

| | | |
|---|---|---|
| 4 inch PVC pipe | 4600 to 5500 Gauss | Best: Working Range |

Velocity
Better: 4 to 12 feet per second

### Forest Dale G.C Experiment—Best Turf in the Valley

It has become the norm to play golf in the summer months with golf courses in poor playing conditions due to summer turf stress. Poor turf quality resulting from poor water permeation, infiltration and overall plant hydration.

Older irrigation systems are designed to cover wall-to-wall and blanket fully and evenly the entire course. However, this is in theory. Golf course irrigation distribution uniformity (DU) is generally very low, ranging 45-65% efficiency. To increase or improve irrigation efficiency, commonly the system is adjusted, re-nozzled or goes through major renovation to gain only a few percentage points.

After an industry standard irrigation efficiency audit was conducted by Utah State University, it showed an incredible increase in DU, without system modification. This rate of improvement greatly disperses water much better over the entire course allowing for much better turf growth, minimizing ‘hot’ or unsightly brown patches. In-addition, overall site appearance and playing conditions where greatly improved from the installation of my method.

The following tables include DU efficiency, magnetic strength and velocity concerning the Forest Dale trial:
Hole 9 fairway before magnet DU: 50%
Hole 9 fairway after magnet DU: 75%
Improvement: 25%
Hole 6 green before magnet DU: 56%
Hole 6 fairway after magnet DU: 74%
Improvement: 18%
   Distribution uniformity data provided by Utah State University

Magnetic Strength

| | | |
|---|---|---|
| 8 inch PVC pipe | 5500-4600 Gauss | Best: Working Range |

Velocity
Better: 4 to 12 feet per second

### BRIEF SUMMARY OF THE INVENTION

The concept that such a vast and powerful improvement with water behavior can derive from a passive technology, until now, is unimaginable. The results can be considered a ‘green’ technology, on the edges of a new renewable energy because of major input reductions—tied to higher performance resulting in even greatly improved outputs. My method and/or my apparatus maybe according to the invention without modifying the existing irrigation systems.

The ability to temporarily re-orient water molecular behavior, which then delivers tangible and real cost savings measures is impressive, in a world that needs to manage water and energy resources desperately.

The addition of my magnet method and apparatus, according to my new optimal process on agronomic, horticultural, or pumping system may produce higher system efficiency, better production and yield, at a significantly lower cost to manufacture and to operate, with less inputs.

According to my invention, I have determined that the combination of the optimal speed of flow of fluid through the supply pipe and the optimal strength of magnetic field should best be dictated by the foregoing information to achieve unexpected significant improvements in the supply fluid such, for example, as water.

### BRIEF DESCRIPTION OF THE DRAWINGS OF CERTAIN EMBODIMENTS OF THE INVENTION

In order to better understand the embodiments of the invention and to see how the same may be carried out in practice, a non-limiting preferred embodiment of the invention will now be described with reference to the accompanying drawings, in which:

FIG. 1 is a diagrammatic pictorial side elevational view of a fluid treatment magnet assembly 10 which is constructed according to an embodiment, and which is illustrated mounted in a threaded coupling union 12; and in fluid communication between a pair of spaced apart fluid pipes 14 and 15.

FIG. 2 is a sectional view of the fluid treatment magnet assembly of FIG. 1.

FIG. 3 is a side elevational view of a magnet rod mounting assembly 16 of FIG. 2.

FIG. 4 is a side elevational view of FIG. 3 with one of the magnet rods removed and in the process of adjusting the strength of the magnetic field generated by the assembly 16.

FIG. 5 is an enlarged end view of the magnet rod mounting assembly of FIG. 3, illustrating it assembled to the magnet assembly 10 of FIG. 1.

FIGS. 3, 6, 7 and 8 are side elevational views of the assembly 16 including face views of a resilient magnet mounting disc 20 and two metal reinforcing discs for overlying the opposite faces of the resilient disc.

FIG. 9 is a graph which is helpful in understanding the results produced by the operation of the method and the fluid treatment magnet assembly according to embodiments of the invention.

Referring now to the drawings in greater detail, the threaded coupling union 12 enables the pipes 14 and 15 to be disconnected, and thus provide access to the magnetic rod assembly 16 for installing or replacing the magnet rods 18 and/or 19 to create a magnetic field within fluid under pressure flowing through the pipes. Thus, if desired, when the union 12 may be uncoupled from the threaded ends of the pipes 14 and 15 to adjust the strength of the magnetic field as hereinafter described in greater detail.

The union 12 is similar to conventional threaded coupling unions which are commonly used in piping systems in buildings today. The inventive union 12 includes a union nut 25 having outer wrench gripping faces such as face 27, for the threadably engaging a union thread piece 29 and engaging a union tailpiece 32. The nut 25 can be rotated to move axially the thread piece 29 toward to away from the tail piece.

When closed, the union 12 connects the pipes 14 and 15 in fluid communication. When the union 12 is opened, the union thread piece 29 moves away from the union tail piece 32 to enable the magnetic field produced by the permanent rods 18 and 19 to be adjusted to a desired amount as hereinafter discussed in greater detail.

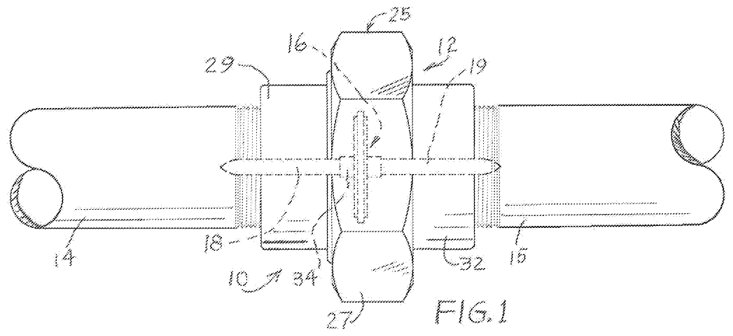

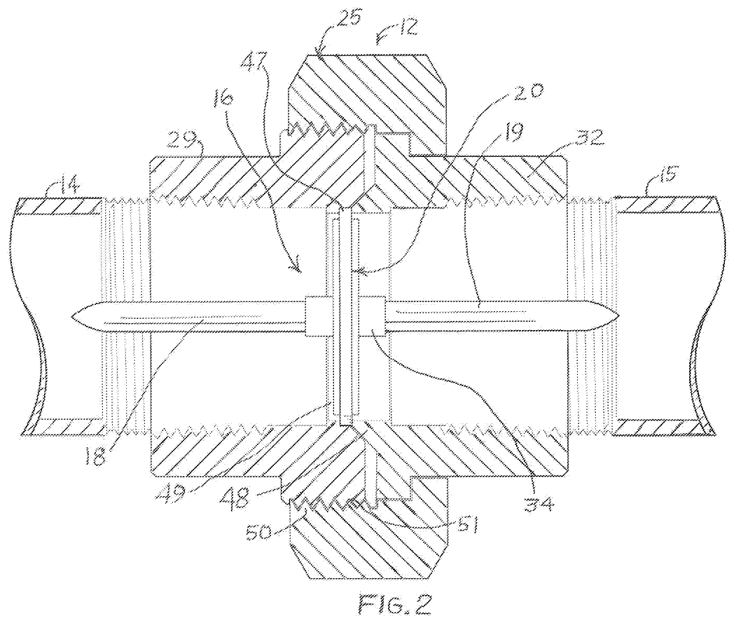

Considering now the magnet mounting assembly 16 in greater detail with reference to FIGS. 1, 2, 3, 4, 5, 6, 7 and 8, the mounting assembly 16 includes the central resilient mounting disc 20 having one of the reinforcing discs secured on opposite faces thereof. A pair of hypodermic internally threaded magnetic rod tubes 34 and 36 are secured in axial alignment with the respective reinforcing discs 21 and 23 for securing threaded ends of the respective magnet rods 18 and 19. The tubes 34 and 36 extend axially and are centrally disposed so that the magnet rods 18 and 19 extend axially into their respective pipes 14 and 15. This location is preferred for establishing the desired magnet field for coming into contact with the fluid such as water flowing through the pipes 14 and 15 and the coupling union 12.

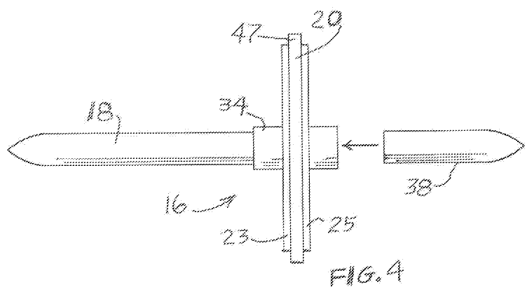

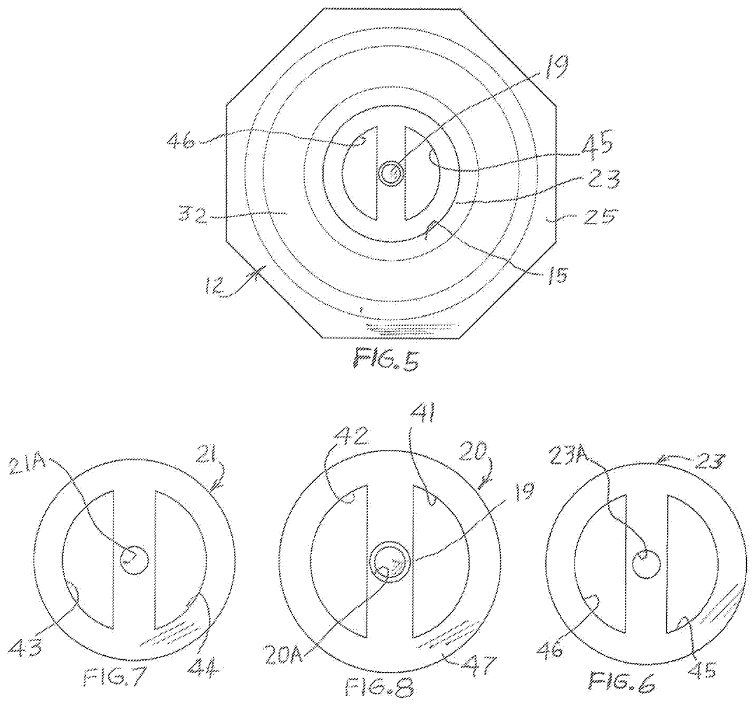

In order to adjust the magnet field, as best seen in FIG. 4, one or more of the magnet rods, such as the rod 19 can be replaced by a short magnetic rod 38 to reduce the overall magnetic field intensity. A longer magnetic rod (not shown) than the rod 19 may be used to increase the intensity, if desired. Also, it will become apparent to those skilled in the art that other magnet rods may be positioned on the reinforcing discs at various locations for adding in addition to or in place of the magnet rod or rods as shown.

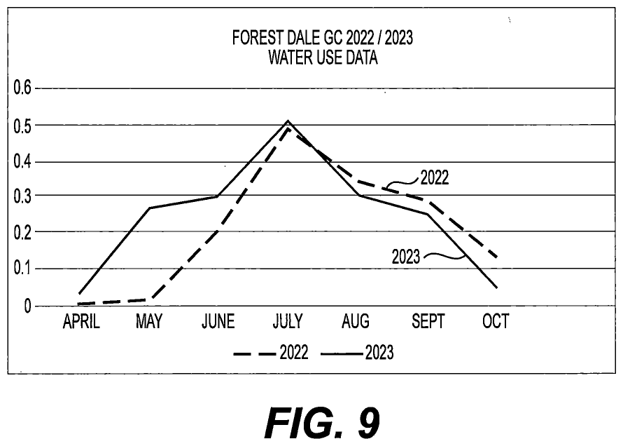

As best seen in FIGS. 5, 6, 7 and 8, the resilient disc 20 may be composed of a flexible suitable resilient material such as rubber or the like elastomeric material, and includes semi circular openings 41 and 42 for permitting the fluid to flow there through.

The reinforcing discs 21 and 23 may be each composed of a rigid material such as a flexible metal such for example as a suitable stainless steel. The disc 21 may have a pair of fluid receiving pass through openings 43 and 44. The disc 23 may be similar to the disc 21 and may have a pair of fluid receiving pass through openings 45 and 46. Additional openings may be employed, and different shapes of openings may be employed as well. However, all of the openings in the discs 20, 21 and 23 may be aligned axially respectively to enable fluid to pass there through all of the assembled discs.

Although the invention has been described with reference to the above examples, it will be understood that many modifications and variations are contemplated within the true spirit and scope of the embodiments and claims of the invention as disclosed and claimed herein. Many modifications and other embodiments are intended and contemplated to be included within the scope of the appended claims. Although specific terms are employed herein, they are used in a generic and descriptive sense only and not for purpose of limitation. For example, the discs 20, 21 and 23 may be generally circular in shape, but other shapes and configurations are contemplated within the true spirit and scope of the invention.

As best seen in FIGS. 5, 6, 7, 8 and 9, the magnet mounting assembly 16 is secured within the threshold coupling union 12 by the resilient magnet mounting disc 20. An annular peripheral edge 47 of the resilient disc 20 fits transversally within the union against an internal annular ridge 48. When the coupling union 12 is closed, an annular portion 49 of union compresses the annular peripheral edge 49 against the annular ridge 48 to help seal the mounting assembly in place.

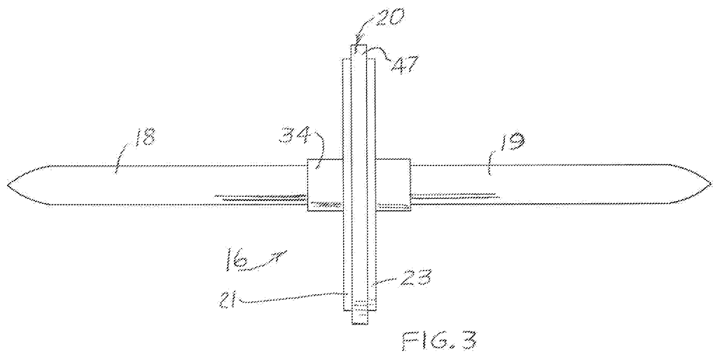

As best seen in FIG. 9, an enlarged sectional view of FIG. 2, internal threads 49 of the nut 25 threadably engage external threads 51 of the thread piece 29 to enable the nut to cause the thread piece move axially, between open and closed positions away from and against the thread piece 29 respectively. FIG. 9 shows the union 12 in the closed position with the mounting assembly 16 inside of it and secured in place.

When the union nut 25 is rotated to cause the tail piece 32 and the pipe 15 to move away from the thread piece 29 and the pipe 14, the nut 25 may move entirely off of the thread piece 29 or a sufficient distance away from the off of the thread piece 29 to permit sufficient space to enable the magnet mounting assembly 16 to be inserted or removed from the coupling union 12 for adjusting the magnetic field intensity produced by magnets 18 and 19.

1. A method of improving supply fluid behavior and performance, comprising: creating an improved magnetic field to interact with supply fluid flowing through a pipe at a given speed, and adjusting the strength of the magnetic field relative to a given speed of the fluid flow to achieve significantly improved results of the supply flow.

2. A method according to claim 1, wherein the fluid is water.

3. A method according to claim 1, wherein the fluid speed is between about 4 feet and about 18 feet per seconds to achieve an improved result.

4. A method according to claim 1, wherein the fluid speed is between about 5 feet and about 17 feet per second to achieve an improved operational flow range.

5. A method according to claim 4, wherein the fluid speed is between about 4 feet and about 12 feet per second to achieve an improved working flow range.

6. A method according to claim 5, wherein the fluid speed is about 6 feet per second to achieve an optimal flow speed.

7. A method according to claim 5, wherein the field strength is between about 4,400 Gause and about 5,800 Gause for a one inch pipe.

8. A method according to claim 7, wherein the field strength is between about 4,600 Gause and about 5,500 Gause to achieve an improved working magnetic field for a one inch pipe.

9. A method according to claim 5, wherein the field strength is between about 2,300 Gause and about 4,700 Gause for a two inch pipe.

10. A method according to claim 9, wherein the field strength is between about 2,800 Gause and about 4,150 Gause for a two inch pipe for an improved magnetic field.

11. A method according to claim 5, wherein the magnetic field is about 3,550 Gause for an optical magnetic field for a two inch pipe.

12. A magnetic mounting assembly for mounting inside of a threaded coupling union, the union being adapted to connect at least a pair of pipes in fluid communication, and a magnet mounting assembly being disposed within the coupling assembly.

13. A magnetic mounting assembly including a resilient member.

14. A magnetic mounting assembly according to claim 13, including a pair of rigid discs.

15. A fluid treatment magnetic assembly, comprising:
A threaded coupling union for connecting pipes in fluid communication; and
at least one magnet mounted within the coupling union to magnetize a fluid flowing through the union.

16. A fluid treatment magnet assembly according to claim 15, wherein the magnet is a permanent magnet.
